(19) United States
(12) Patent Application Publication
(10) Pub. No.: US 2017/0021450 A1
(43) Pub. Date: Jan. 26, 2017

(54) METHOD AND DEVICE FOR LASER MACHINING A SUBSTRATE WITH MULTIPLE LASER RADIATION DEFLECTION

(71) Applicant: LPKF Distribution, Inc., Tualatin, OR (US)

(72) Inventors: Roman Ostholt, Langenhagen (DE); Udo Buenting, Suthfeld (DE); Norbert Ambrosius, Hannover (DE); Malte Schulz-Ruhtenberg, Wunstorf (DE)

(21) Appl. No.: 15/218,098

(22) Filed: Jul. 25, 2016

(30) Foreign Application Priority Data
Jul. 24, 2015 (DE) 10 2015 112 151.4

(51) Int. Cl. B23K 26/082; H01S 3/00; G02F 1/29; B23K 26/0622

(52) U.S. Cl. CPC B23K 26/082; B23K 26/0624; H01S 3/0071; G02F 1/29

(57) ABSTRACT

A method and device for laser machining a substrate, involves deflecting the laser radiation using a galvanometer scanner and an electro-optical deflector. The laser radiation thus deflected multiple times is then directed at a machining position on the substrate. By superposing an additional beam deflection by the electro-optical deflector onto the advance movement in the machining direction, which deflector is operated with steady oscillation excitation for this purpose, the resultant beam deflection follows a circular revolving path. In the process, the series of pulses of a pulsed radiation source is restricted to individual or a plurality of machining positions on the substrate, and forms for example a cutting front so as to thus quickly and reliably produce a kerf having the desired width.

### CROSS-REFERENCE TO RELATED APPLICATIONS

Priority is claimed to German Patent Application No. DE 10 2015 112 151.4, filed on Jul. 24, 2015, the entire disclosure of which is hereby incorporated by reference herein.

### FIELD

The invention relates to a method for machining a substrate by laser radiation.

### BACKGROUND

A method of this type and a device of this type for machining a substrate by means of laser radiation, which is deflected consecutively by a galvanometer scanner and an electro-optical deflector, are already known from the prior art.

For example, U.S. Pat. No. 5,103,334 describes the use of an electro-optical deflector (EOD) for performing quick corrections in a beam scanner. For this purpose, an EOD is used to convert the inertia-related continuous linear beam course of a polygonal scanner into a discontinuous course, the polygonal scanner bringing about the large deflection angles and the EOD making small corrections.

In U.S. Pat. No. 5,065,008, an EOD is used to fine tune the beam position. U.S. Pat. No. 5,936,764 uses an EOD to quickly scan small strips of an object one after the other on a zig-zag course.

U.S. Pat. No. 7,050,208 B2 also proposes combining a high-angle scanner with a rapid EOD to reach particular machining positions with a beam.

To position the beam particularly rapidly, electro-optical deflectors (EOD) and acousto-optical deflectors (AOD) are already used. These practically inertia-free deflectors use transparent materials, usually crystals, of which the refractive indices can be influenced by electrical fields or ultrasound fields and thus enable optical beams to be deflected. Electro-optical deflection units achieve response times in the nanosecond range.

However, a galvanometric optical scanner is based on a motorized scanning mirror. These scanners are generally referred to as galvanometer scanners.

U.S. Pat. No. 7,817,319 B2 relates to a laser machining system for perforating printed circuit boards, which is used to make the machining quicker and more accurate. For this purpose, two scanners are operated such that the first scanner describes a (slow) scanning movement along an axis, while the second (faster) scanner is used to briefly pause the laser beam when the beam source emits a pulse.

WO 2013/147643 A1 relates to a laser scanning device having a beam source, a resonance scanner having a mirror, and a focusing lens. In this case, the scanning region of the resonant scanner is restricted to only use the practically linear region of the sine wave and to dismiss the reversal regions so that the energy is distributed uniformly over a surface to be machined.

WO 2014/152480 A1 relates to a laser machining device for machining a workpiece using laser pulses. In this case, a combination of various scanning methods is used to increase the speed of the laser machining.

The combination of resonant galvanometers of various frequencies connected in line for linearizing the sinusoidal scanning course is also known from DE 43 22 694 A1.

### SUMMARY

An aspect of the invention provides a laser machining method for machining a substrate by laser radiation from a mode-coupled laser beam source, the method comprising: deflecting laser radiation two or more times using at least one first deflection unit including a galvanometer scanner and using at least one second deflection unit including an electro-optical deflector; and directing radiation at a machining position on the substrate, wherein the laser radiation is deflected using the electro-optical deflector as the electro-optical deflector is moved along a closed revolving path, and wherein a pulse frequency of the laser radiation from a mode-coupled pulsed laser radiation source is controlled such that the machining position on the substrate follows the closed revolving path in a predetermined region depending on the pulse frequency of the laser radiation of single pulses and/or a series of pulses.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view of a device for laser machining a substrate;

FIG. 2 shows the outline of a circular, second beam deflection of the laser radiation, superposed on the first beam deflection;

FIG. 3 shows the laser radiation being controlled as a series of pulses along a cutting front in the machining direction; and

FIG. 4 shows the laser radiation being controlled as single pulses along two lateral boundary lines in parallel with the machining direction.

### DETAILED DESCRIPTION

An aspect of the invention relates to a method for machining a substrate by laser radiation that is deflected multiple times by means of at least one deflection unit having a galvanometer scanner and by means of at least one deflection unit having an electro-optical deflector and is directed at a machining position on the substrate. The invention also relates to a device designed for carrying out the method, comprising two deflection units arranged in line for deflecting the laser radiation onto a machining position on the substrate, a first deflection unit comprising a galvanometer scanner and a second deflection unit comprising an electro-optical deflector.

A problem addressed by the invention is that of increasing the machining speed while ensuring high machining quality at the same time.

According to an aspect of the invention, a method is thus provided in which the laser radiation is deflected by means of the electro-optical deflector as said deflector is moved along an annularly closed revolving path, and the pulse frequency of the laser radiation of a mode-coupled pulsed laser radiation source is controlled such that the machining position on the substrate is carried out in a predetermined region of the revolving path depending on the pulse frequency of the laser radiation by single pulses or a series of pulses each having a different machining position on the substrate. The invention is based on the finding that it is possible to spatially separate very high-frequency pulses by deflecting the laser radiation twice, specifically first for rough positioning by means of the galvanometer scanner and then for fine positioning by means of the electro-optical deflector. By operating the electro-optical deflector such that during resonant operation it performs a stationary, constant movement along a defined revolving path, the laser machining can be restricted to the desired machining position by appropriately controlling either the beam feed, e.g. by pausing for the duration of individual pulses, or the pulse frequency. For this purpose, a conventional galvanometer scanner deflects the beam to a known degree of precision onto the position to be machined over the course of the desired movement path. In addition, a resonant deflection unit based on the electro-optical deflector makes it possible to deflect the laser beam according to the revolving path. This revolving path corresponds, for example, to the diameter of a hole to be made in the substrate or to the width of a kerf. By deflecting the laser radiation along the revolving path, it thus becomes possible to spatially separate the laser pulses, even in the event of very high repetition rates in the MHz range. By means of an in particular uniform series of pulses during a full revolution on the revolving path, which is preferably circular in this case, the desired hole is made by a plurality of partially overlapping single pulses, which thus each remove a portion of the inner wall surface of the hole. In the process, the laser radiation can be deflected by means of both the galvanometer scanner and the electro-optical detector either simultaneously in a superposed manner in a dynamic process or in separate time segments, such that the beam is, for example, deflected by means of the electro-optical deflector during a time phase in which the beam deflection is unchanged by the galvanometer scanner.

Another particularly advantageous application when machining a substrate by laser radiation in the manner according to the invention makes laser milling possible. In this case, volumes of substrate are removed by the laser radiation in order to generate microstructures. Unlike the usual removal line by line in which regular groove-shaped depressions are inevitable on the surface, a circular or arcuate movement of the laser focus produces smoothing on the substrate, and this either reduces depressions significantly or even prevents depressions appearing.

In addition, this also allows in particular 3D surfaces to be produced, for example freeform surfaces, which, according to the invention, can not only be produced particularly quickly but the surface thus created is also of a high quality. In addition, microstructures unknown before now can also be produced in this way.

Although the invention has already proven promising when using electro-optical deflectors, acousto-optical deflectors can also be used according to the invention instead of the electro-optical deflectors.

A particularly advantageous embodiment of the invention is also achieved by the laser radiation being deflected onto the substrate in a manner restricted to an active portion of a full revolution on the revolving path. By setting an in particular regularly recurring series of pulses in the region of the forwards direction of the movement path, a corresponding arcuate cutting front can be produced. In the region of a rear side facing away from the forwards direction, the laser radiation is paused. This considerably improves the perforation and cutting processes for structuring in particular compact (HDI) printed circuit boards.

In particular, according to a particularly preferred embodiment of the method, the laser radiation is thus deflected onto the substrate in a particular machining position according to a recurring sequence of single pulses and/or series of pulses in different machining positions. In the process, the machining position on the substrate is set by accordingly adjusting the active portion on the revolving path according to a machining direction determined by the first beam deflection by means of the galvanometer scanner, such that for example a cutting front is always arranged in the forwards direction of the next machining position.

Furthermore, it is particularly advantageous for the laser radiation in the form of a series of pulses to be deflected onto the substrate along a curved portion between the lateral boundary lines in the forwards direction in relation to the machining direction determined by means of the galvanometer scanner. This ensures a constant width of the cutting path, regardless of whether an advance direction of the machining position on the substrate is constantly changing, since the curved portion acting as a cutting front is oriented for this purpose.

In another, likewise particularly advantageous embodiment of the invention, the single pulses or series of pulses are introduced in parallel with the machining direction determined by means of the galvanometer scanner, preferably at a maximum spacing from a center line in the forwards direction in relation to the machining direction determined by means of the galvanometer scanner.

In another, likewise particularly expedient embodiment of the invention, the second beam deflection by means of the electro-optical deflector follows a circular revolving path, and so comparably simple control of the electro-optical deflector during operation is made possible by a steady resonant circuit. In addition, holes having a circular cross section can thus be made in the substrate in a simple manner.

In this case, the electro-optical deflector is preferably operated resonantly, i.e. with steady periodic oscillation, in order to thus achieve particular high dynamics in the beam deflection.

Furthermore, it has proven particularly practical for the deflection to be detected, in particular the rate of change of the deflection by the galvanometer scanner, and for the pulse frequency to be adjusted on the basis of the measured values detected. This again considerably improves the accuracy of the adjustable machining position since not only is the target position of the deflection by the galvanometer scanner used as the basis for the pulse control, but so too are the measured values of the beam deflection.

Furthermore, the problem addressed by the invention—that of producing a laser machining device designed for carrying out the method, comprising at least two deflection units arranged in line for fed-in laser radiation, at least a first deflection unit comprising a galvanometer scanner and at least a second deflection unit comprising an electro-optical deflector—is also solved in that the laser radiation can be deflected on an annularly closed revolving path by means of the second deflection unit, and in that the pulse frequency of the pulsed laser radiation can be controlled by means of a control unit such that the machining by the action of the laser radiation on the substrate is carried out in a manner restricted to a predetermined region of the revolving path depending on the pulse frequency of the laser radiation by means of single pulses and/or a series of pulses having the respective different machining positions on the substrate. As a result, spatial resolution of the single pulses in separate machining positions on the substrate is achieved first, owing to an in particular steady oscillation excitation of the electro-optical deflector. The single pulses or the series of pulses can also be introduced into the substrate in a targeted manner such that they are introduced line parallel to a center line of the advance movement of the machining position, for example, as lateral boundary lines, or as a cutting front corresponding to a semicircle in front in the machining direction. In the process, the laser radiation is fundamentally deflected twice when the galvanometer scanner and the electro-optical deflector are connected in line, wherein the second deflection can take place during a progressive change to the first beam deflection in a dynamic process, or during an unchanged, stationary first beam deflection.

Although the device according to the invention can advantageously be used in different laser applications, it has nevertheless proven particularly advantageous if the device comprises a mode-coupled beam source for ultra-short laser pulses having a pulse duration of from a few femtoseconds (10⁻¹⁵ s) up to a few picoseconds (10⁻¹² s), in which before now it was not possible to produce single pulses that could be positioned spatially separately from one another on the substrate.

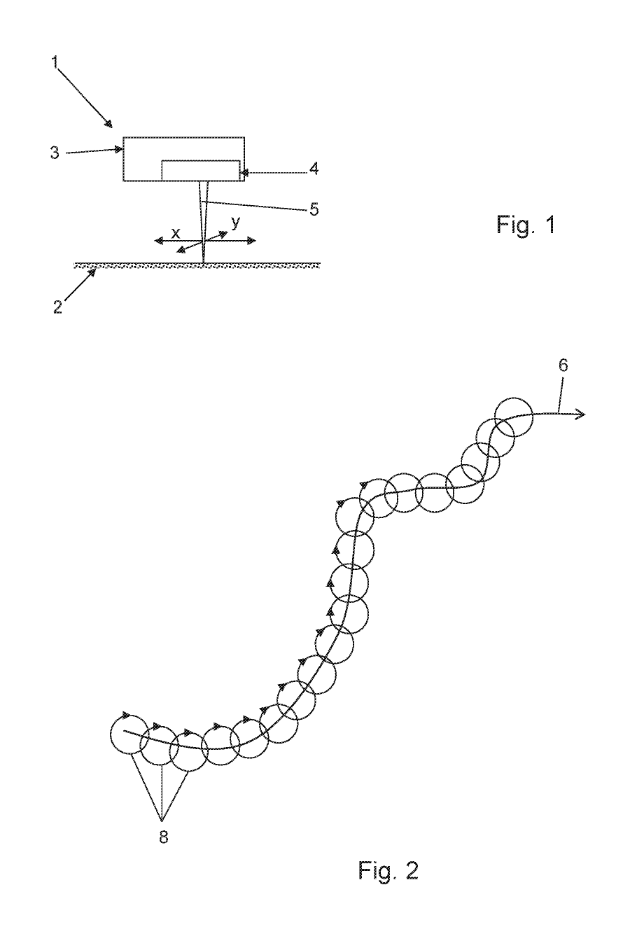

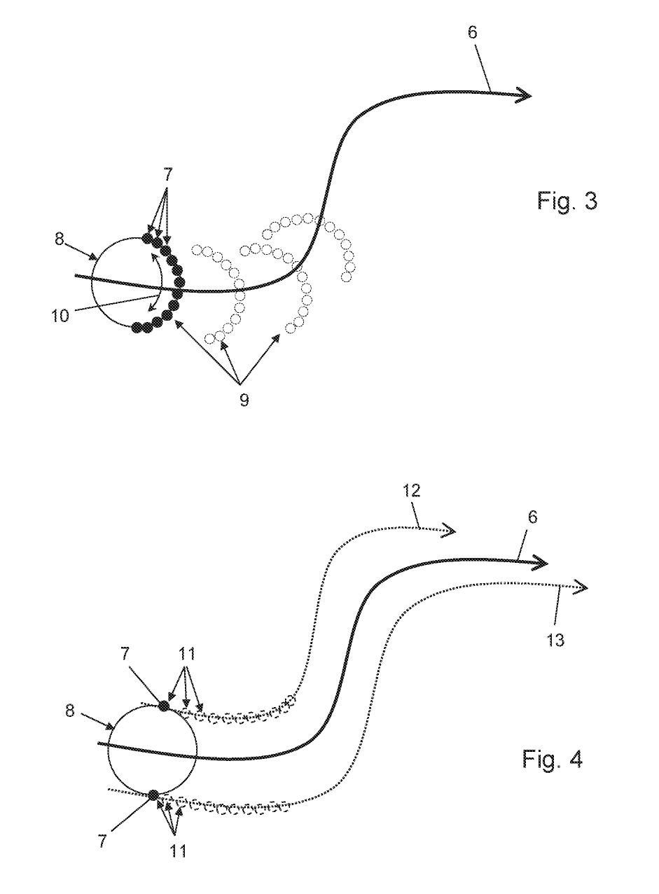

The invention will be described in more detail below on the basis of FIGS. 1 to 4, FIG. 1 showing a schematic view of a device 1 for laser machining a substrate 2, comprising at least two deflection units 3, 4 arranged in line for laser radiation 5 that can be deflected towards different spatial axes X, Y. In this case, the first deflection unit 3 comprises a galvanometer scanner, which is known per se, and a second deflection unit 4 that is integrated in the first deflection unit 3 and comprises an electro-optical deflector. As the substrate 2 is being machined, the machining position of the laser radiation 5 on the substrate 2 follows a linear machining direction 6, which corresponds to the deflection of the laser radiation 5 by means of the first deflection unit 3 without deflection at the second deflection unit 4. As can be seen in FIGS. 2 to 4, this advance movement of each machining position 7 in the machining direction is superposed with an additional beam deflection of the laser radiation 5 by means of the second deflection unit 4. For this purpose, the second deflection unit 4 is operated with a steady oscillation excitation such that the resultant beam deflection by the second deflection unit 4 follows a circular revolving path 8. By means of a control unit (not shown), the pulse frequency of a pulsed radiation source is adjusted such that the action of the radiation on the substrate 2 is restricted to individual or a plurality of successive machining positions 7 on the substrate 2. For this purpose, a series of pulses 9, as shown in FIG. 3, or discrete single pulses, as shown in FIG. 4, are generated in a predetermined region of the revolving path 8, and these form, as a series of pulses 9, a curved portion 10 of a cutting front in a portion of the revolving path 8 that faces forwards in the machining direction 6. This reliably produces a kerf having the desired width. FIG. 4 shows, merely by way of example, one manner of controlling the laser radiation 5, in which single pulses 11 are introduced along laterally delimiting side lines 12, 13 parallel to the machining direction 6 by precisely two single pulses 11 being deflected onto the substrate 2 during one complete revolution on the revolving path 8. Owing to the in particular steady oscillation excitation of the electro-optical deflector of the second deflection unit 4, the single pulses 11 are spatially resolved into separate machining positions on the substrate 2, either in single pulses 11 or series of pulses 9. In this respect, the laser radiation 5 is fundamentally carried out with the two deflection units 3, 4 connected in line, wherein the second deflection can take place during a progressive change to the first beam deflection in a dynamic process, or during an unchanged, stationary position of the first deflection unit 3, as shown in FIG. 1.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SIGNS

1 device

2 substrate

3 deflection unit

4 deflection unit

5 laser radiation

6 machining direction

7 machining position

8 revolving path

9 series of pulses

10 curved portion

11 single pulse

12 side lines

13 side lines

X, Y spatial axis

1. A laser machining method for machining a substrate by laser radiation from a mode-coupled laser beam source, the method comprising:
deflecting laser radiation two or more times using at least one first deflection unit including a galvanometer scanner and using at least one second deflection unit including an electro-optical deflector; and
directing radiation at a machining position on the substrate,
wherein the laser radiation is deflected using the electro-optical deflector as the electro-optical deflector is moved along a closed revolving path, and in that
wherein a pulse frequency of the laser radiation from a mode-coupled pulsed laser radiation source is controlled such that the machining position on the substrate follows the closed revolving path in a predetermined region depending on the pulse frequency of the laser radiation by means of single pulses and/or a series of pulses.

2. The method of claim 1, wherein the laser radiation is deflected onto the substrate in a manner restricted to a portion of a full revolution on the revolving path.

3. The method of claim 1, wherein the laser radiation is deflected into a particular machining position on the substrate according to a recurring sequence of single pulses and/or series of pulses in different machining positions.

4. The method of claim 1, wherein the laser radiation, in the form of a series of pulses, is deflected onto the substrate along a curved portion between lateral side lines in the forwards a forward direction in relation to the machining direction, determined by means of using the galvanometer scanner.

5. The method of claim 1, wherein the single pulses and/or the series of pulses are introduced along one or both of a first and second side line parallel to the machining direction, determined using the galvanometer scanner.

6. The method of claim 1, wherein the second beam deflection using the electro-optical deflector follows a circular revolving path.

7. The method of claim 1, wherein the electro-optical deflector is operated resonantly.

8. The method of claim 1, further comprising:
detecting the deflection; and
adjusting pulse duration and/or pulse frequency based on measured values detected.

9. A laser machining device for carrying out the method of claim 1, the device comprising:
a first deflection unit and a second deflection unit arranged in line so as to deflect the laser radiation onto the machining position on the substrate,
wherein the first deflection unit includes a galvanometer scanner, and
wherein the second deflection unit includes an electro-optical deflector,
wherein the laser radiation can be deflected along a closed revolving path using the second deflection unit, and
wherein the pulse frequency of the laser radiation of a pulsed radiation source can be controlled using a control unit such that machining of the substrate is restricted to a predetermined region of the revolving path depending on the pulse frequency of the laser radiation by single pulses and/or a series of pulses.

10. The device of claim 9, characterized in that the device (1) comprises a mode-coupled beam source for ultra-short laser pulses.

11. The method of claim 1, wherein the predetermined region includes a curved portion.

12. The method of claim 1, wherein the pulse frequency is of the single pulses.

13. The method of claim 1, wherein the pulse frequency is of the series of pulses.

14. The method of claim 1, wherein the pulse frequency is of the single pulses and the series of pulses.

15. The method of claim 1, wherein the electro-optical deflector is operated using a steady periodic oscillation.

16. The method of claim 1, further comprising:
detecting a rate of change of deflection by the galvanometer scanner; and
adjusting pulse duration and/or the pulse frequency based on measured values detected.

17. The method of claim 8, comprising adjusting the pulse duration based on the measured values detected.

18. The method of claim 8, comprising adjusting the pulse frequency based on the measured values detected.

19. The method of claim 8, comprising adjusting the pulse duration and the pulse frequency based on the measured values detected.
